(19) United States
(12) Patent Application Publication
(10) Pub. No.: US 2006/0102534 A1
(43) Pub. Date: May 18, 2006

(54) Bypass filter assembly

(76) Inventor: Manuel S. Faria, Tipton, CA (US)

Correspondence Address: ST. ONGE STEWARD JOHNSTON & REENS, LLC, 986 BEDFORD STREET, STAMFORD, CT, 06905-5619, US

(21) Appl. No.: 10/989,066

(22) Filed: Nov. 15, 2004

(51) Int. Cl. B01D 35/14

(52) U.S. Cl. 210/130; 210/420; 210/433.1

(57) ABSTRACT

A bypass filter assembly is disclosed generally comprising a bypass housing having a bypass chamber, in which a ball bearing is biased against an aperture by a spring. In certain advantageous embodiments, the aperture is located in a bypass cap removably disposed in a cavity in a base plate. In some embodiments, a bearing seat is formed from a beveled area in the inner face of the bypass housing around the aperture. In certain embodiments, a bearing seat is formed from a tubular column with slots extending into the bypass chamber.

### FIELD OF THE INVENTION

The present invention relates to an apparatus for bypassing a filter element in a filter assembly. More specifically, the invention relates to a bypass valve assembly for use in oil filters.

### BACKGROUND OF THE INVENTION

Known systems for lubricating an engine circuitously pump oil over and around moving engine parts with friction bearing surfaces such as valves and piston rods. With the passage of time, this oil acquires various contaminants, which are often particulates that have been shaved off of the engine parts themselves. As these abrasive particles circulate through the engine with the oil, they cause additional particulates to be shaved off of the engine parts. Therefore, a filter is typically placed somewhere in the path of the oil flow. This filter typically contains a filter element sleeve made from a porous material through which the oil can flow. After the oil has entered the filter, it must pass through this filter element before exiting the filter again. As the oil flows through the filter element, the particulates that have accumulated in the oil are retained.

One problem with these filters is that the filter element becomes clogged with the particulates that it is designed to retain. When a large amount of particulates are retained, the oil passing through the filter is impeded, thereby decreasing the volume of oil exiting the filter. As the volume of the flow diminishes, parts of the machine or engine that are normally lubricated receive inadequate lubrication. In some cases, the filter element becomes completely blocked, and thus, oil ceases to flow through the filter altogether. This not only can result in serious damage to the engine, but can even cause the engine to seize.

Additionally, when the filter element becomes clogged and the flow of oil is restricted, the differential pressure across the filter element increases. Because the material used to make the filter element is often relatively weak for purposes of permeability or cost, the increased pressure will often cause the filter element to tear. When this occurs, the filter element will sometimes break apart, and pieces will be swept away with the oil, thereby adding to, rather than reducing, the amount of particulates in the oil that cause wear to the engine parts over which the oil flows.

Another problem with these filters is that, when an engine in a cold environment is started, the viscosity of the oil is high, and thus, it resists flowing through the filter element. Just as when the oil is prevented from flowing through the filter element when the element is clogged, when oil flow through the filter element is restricted due to increased viscosity of the oil, inadequate lubrication, no lubrication, or torn filter elements may result.

Therefore, it is advantageous to have a mechanism that permits the oil to bypass the filter element when oil is not able to flow through the element. Accordingly, several bypass valve assemblies for use in filters have been suggested. Such assemblies, which form a barrier between the space surrounding the outside of the filter element and the space inside the filter element, are typically responsive to an excessive amount of pressure in the space surrounding the outside of the element.

When a filter element through which the oil normally flows becomes clogged, or the oil cannot flow through the element beause the oil is too viscous, the pressure in the filter housing in the space surrounding the outside of the filter element increases. The bypass valve responds to a certain predetermined amount of pressure by opening, thereby permitting the oil to bypass the filter element by flowing through this opening, into the space inside the filter element, and ultimately back out of the filter housing. However, many of these assemblies are complex, include many parts, or have parts that render the assembly difficult to disassemble and reassemble, thereby resulting is assemblies that are costly and/or difficult to clean.

In order to provide a bypass valve assembly that is inexpensive to manufacture, easily cleaned, and easily disassembled and reassembled, it has been proposed to provide an assembly that uses a simple ball and spring check valve, such as that disclosed in U.S. Pat. No. 4,622,136 to Karcey, which is assigned to the assignee of the present application and which is incorporated herein by reference. In this type of bypass valve assembly, a ball bearing is held against an aperture by a spring. When the pressure in the space surrounding the outside of the filter element exceeds a certain threshold value, which value is dependent upon the tension of the spring, the pressure will force the ball bearing against the spring and away from the aperture, thereby compressing the spring, and oil can flow through the aperture, into the space inside of the filter element that was bypassed, and ultimately out of the filter housing.

One disadvantage of such bypass valve assemblies, however, is that the volume flow rate of the oil is necessarily limited by the area of the space surrounding the slightly displaced ball bearing. If a sufficient amount of oil is not able to pass through the valve assembly at a sufficiently fast rate, inadequate lubrication of the engine parts can still result. Further, attempts to increase the amount of oil flowing through the aperture and around the outside of the ball bearing increases the pressure on, and movement of, the ball bearing, thereby rendering the simple ball and spring arrangement less stable and consistent.

What is desired, therefore, is an apparatus for ensuring that oil bypasses a filter element and continues to flow when the filter element becomes clogged, or when the oil is too viscous to pass through the element, while maintaining both the stability and consistency of the bypass mechanism. What is further desired is an apparatus for increasing the volume flow rate of oil that bypasses a filter element in a filter assembly. What is also desired is an apparatus for bypassing a filter element in which the bypass mechanism can be easily disassembled and reassembled to permit easy cleaning or replacement of its parts.

### SUMMARY OF THE INVENTION

Accordingly, it is an object of the present invention to provide a bypass filter assembly that provides an increased flow rate for oil that bypasses a filter element without decreasing the stability of the various parts of the bypass mechansim or the consistency of the operation of those parts.

It is a further object of the present invention to provide a bypass filter assembly that is easily disassembled and reassembled.

To overcome the deficiencies in the prior art and to achieve at least some of the objects and advantages listed, the invention comprises a bypass filter assembly including a main housing having an interior surface, a filter element disposed in the housing, the filter element having an exterior surface, an inflow chamber comprising the space between thr interior surface of the housing and the exterior surface of the filter element, an outflow chamber comprising the space inside the filter element, and a bypass valve assembly connecting the inflow chamber to the outflow chamber, the valve assembly comprising a bypass housing having a bypass chamber, an input end, and an output end, wherein the input end has an aperture for introducing oil into the bypass chamber, wherein the output end has at least one outlet port for discharging oil from the bypass chamber, a spring disposed in the bypass chamber, and a ball bearing at least partially disposed in the bypass chamber and biased against the aperture by the spring.

In another embodiment, the invention comprises a bypass filter assembly including a bypass housing having a bypass chamber, an input end, and an output end, wherein the input end of the housing has an aperture for introducing oil into the bypass chamber, wherein the output end of the housing has at least one outlet port for discharging oil from the bypass chamber, a spring disposed in the bypass chamber, and a ball bearing at least partially disposed in the bypass chamber and biased against the aperture by the spring.

### BRIEF DESCRIPTION OF THE DRAWINGS

FIG. 1 is an exploded isometric view of metallic particle trap bypass filter in accordance with the invention.

FIG. 2 is an exposed side view in partial cross-section of the bypass filter of FIG. 1 illustrating the flow path of oil flowing through a filter element.

FIG. 3 is an exposed side view in partial cross-section of the bypass filter of FIG. 1 illustrating the flow path of oil bypassing a filter element.

FIG. 4A is an exploded isometric view of one embodiment of the magnetic rod and bypass valve of the filter of FIG. 1.

FIG. 4B is an isometric view of the magnetic rod and bypass valve of FIG. 4A when fully assembled.

FIG. 5 is an exposed side view in partial cross-section of the bypass assembly of the filter of FIG. 1.

FIG. 6 is an isometric view of the tube of the bypass assembly of FIG. 5.

FIG. 7 is an end elevational view of one embodiment of the bypass assembly of FIG. 5.

FIG. 8 is an end elevational view of another embodiment of the bypass assembly of FIG. 5.

FIG. 9 is an exploded isometric view of the filter element of claim 1 in conjunction with a second filter element and a coupling therefor.

FIG. 10A is an end elevational view of the coupling of FIG. 9.

FIG. 10B is cross-sectional side view of the coupling of FIG. 9.

### DETAILED DESCRIPTION OF THE DRAWINGS

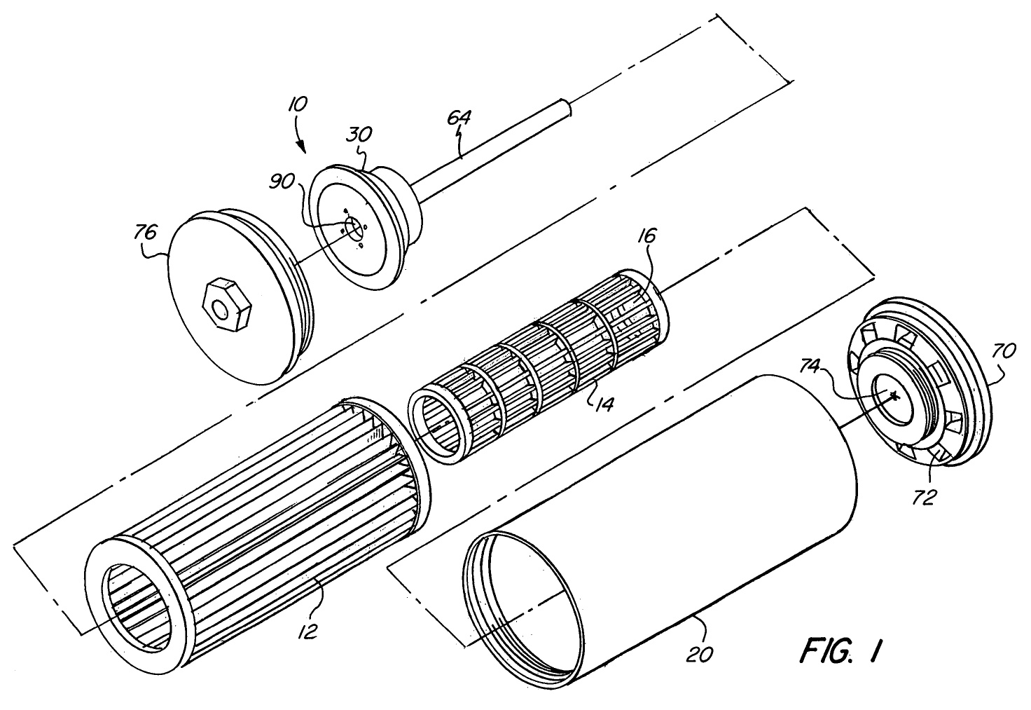

The basic components of one embodiment of a filter 10 in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

In the embodiment depicted in FIG. 1-3, a filter element 12 is disposed inside a housing 20. In certain embodiments, the filter element 12 is a self-sustaining filter element. In other embodiments, the filter element 12 is a sleeve disposed on a filter element support member 14. In certain embodiments, the support member 14 is merely a frame. In certain other embodiments, the support member 14 is a tube having a plurality of holes 16 therein, such as, for example, longitudinal slots, latitudinal slots, or circular openings.

In certain embodiments, the top of the housing is integrally formed with the side of housing 20. In other embodiments, the top of the housing 20 is a detachable top cap 70, which facilitates easy removal of the sleeve 12 for cleaning or replacement. The top of the housing has at least one housing inlet port 72, which is in fluid communication with an inflow chamber 80, for introducing oil into the housing 20 and at least one housing outlet port 74, which is in fluid communication with an outflow chamber 86, for discharging liquid from the housing 20. Similarly, in some embodiments, the bottom of the housing is integrally formed with the side of the housing 20, while in other embodiments, the bottom of the housing 20 is a bottom cap 76, which facilitates easy removal of the sleeve 12 and bypass assembly 30 for cleaning or replacement.

In certain advantageous embodiments, the sleeve 12 is comprised of a stainless steel mesh. Thus, the sleeve 12 is much stronger than traditional paper filters, and can withstand a great deal of pressure in the inflow chamber 80 without tearing. Accordingly, the bypass assembly 30 can be arranged to only open the bypass valve 90 at very high threshold pressure, thereby maximizing the amount of oil that will be forced through the sleeve 12.

In certain advantageous embodiments, the sleeve 12 is pleated. This provides the sleeve 12 with more rigidity, thereby making it less prone to collapse as a result of presure in the inflow chamber 80, thereby allowing the bypass assembly 30 to be arranged such that the bypass valve 90 will only open at a higher threshold pressure. Additionally, this provides the filter element with much greater surface area through which the oil can flow, thereby increasing the volume flow rate of the oil in order to compensate for any decrease that may result from using a filter element sleeve 12 designed to trap yet smaller particles, and further, providing more area that must become clogged before a sufficient amount of pressure builds in the inflow chamber 80 to open the bypass valve 90.

A bypass valve assembly 30, which has a bypass valve 90, is disposed in the bottom of the sleeve 12 in order to permit oil in the housing 20 to bypass the sleeve 12, the process of which is further described below.

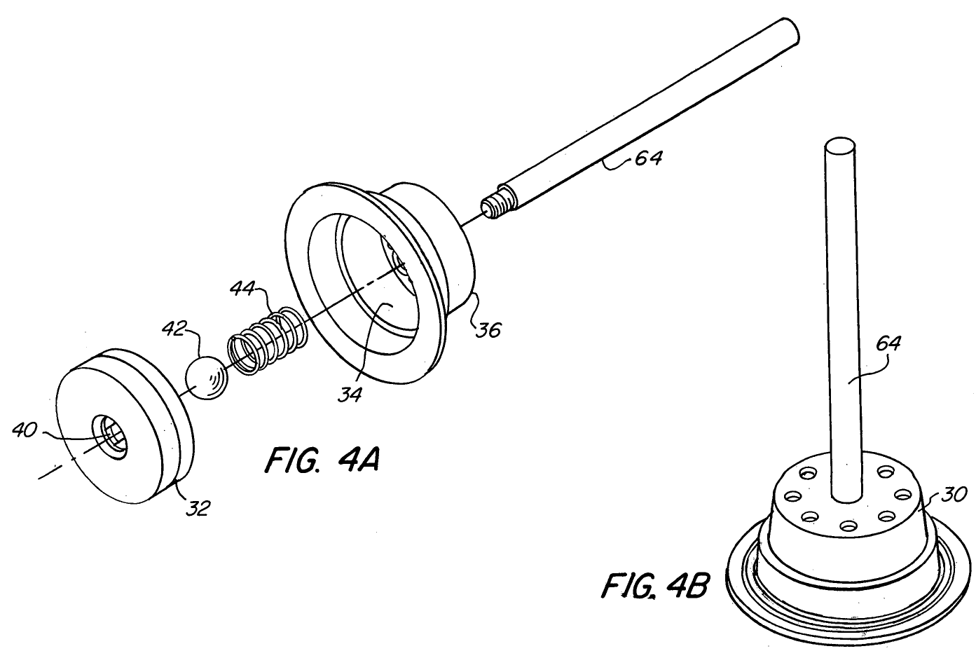

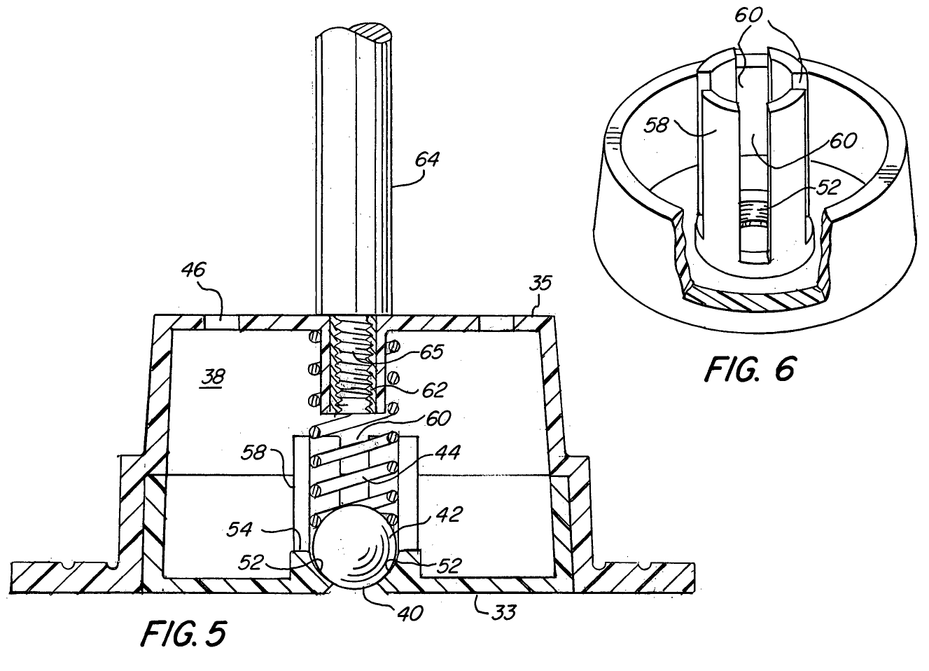

The basic components of some embodiments of the bypass valve assembly 30 are illustrated in FIGS. 4-8. The assembly has an input end 33, an output end 35, and a bypass chamber 38. The input end has an aperture 40 for introducing oil into the bypass chamber 38, and the output end 35 has at least one bypass outlet port 46 for discharging oil from the bypass chamber 38.

In the particular embodiments shown in these figures, the bypass assembly 30 is a ball and spring check valve. Accordingly, inside the bypass chamber 38, a ball bearing 42 is biased against the aperture 40 by a spring 44 and operates as further described below.

In certain advantageous embodiments, the bypass assembly 30 comprises a base plate 36 with a cavity 34, and the input end 33 of the bypass assembly 30 is a bypass cap 32 that is disposed in the cavity 34, thereby defining the bypass chamber 38. This arrangement permits one to easily open the bypass valve assembly 30, which may be desired for a variety of reasons, such as, for example, to clean the assembly 30 when it becomes clogged with particulate matter over time as a result of serving as a conduit through which unfiltered oil flows, or to replace the spring with another spring having a different tension in order to change the pressure at which the ball bearing 42 will move away from the aperture 40.

In certain advantageous embodiments, a ball bearing seat is formed from a beveled area 52 of the inner face 54 around the aperture 40. This beveled area 52 of the inner face 54 provides a greater area through which the oil may flow around the outside of the ball bearing 42 when the ball bearing 42 is forced away from the aperture 40. Additionally, this beveled area 52 helps guide the ball bearing 42 back over the aperture when spring 44 decompresses and biases the ball bearing 42 against the inner face 54.

In certain advantageous embodiments, a ball bearing seat is formed from a tube 58 extending from the inner face 54 up into the bypass chamber 38. The tube 58 ensures that the ball bearing 42 moves only longitudinally in the direction of compression/decompression of the spring 44 when the ball bearing 42 experiences increased pressure or movement. In certain embodiments, the wall of the tube 58 has at least one slot 60 to allow the oil to flow out of the tube 58 and into the bypass chamber 38.

In certain embodiments, a ball bearing seat is formed from both the beveled area 52 and the tube 58.

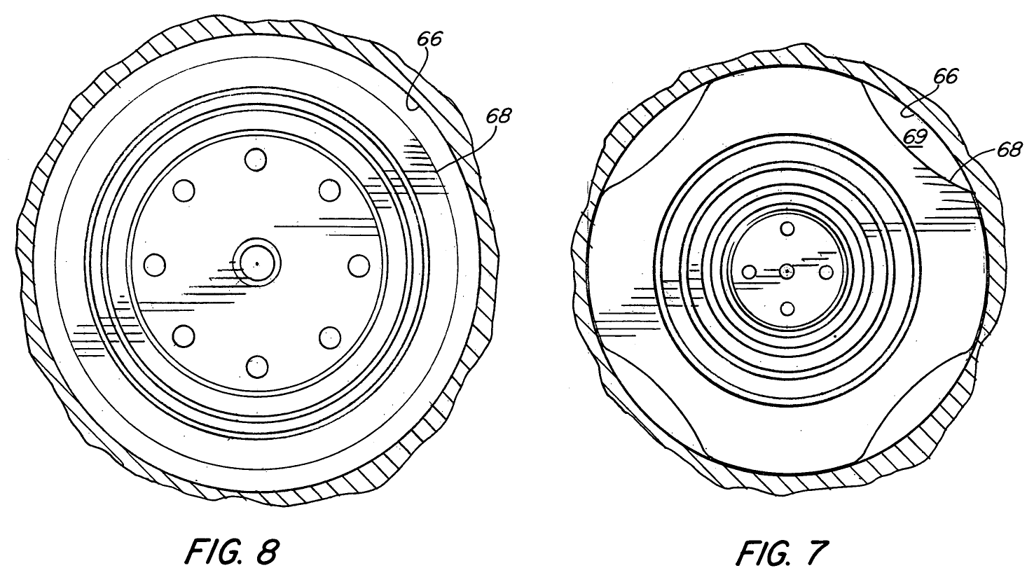

As shown in FIG. 7, in certain embodiments, the outer rim 68 of the bottom of the base plate 36 is smaller than the interior surface 66 of the housing 20, such that the oil can flow freely through the space between the base plate 36 and the interior surface 66 to the bottom of the bypass valve assembly 30. As shown in FIG. 8, in certain other embodiments, the outer rim 68 of the bottom of the base plate 36 abuts the interior surface 66 of the housing 20, and at least one segment of the outer rim 68 has been shaped such that at least one gap 69 exists between the outer rim 68 and the interior surface 66.

A magnet 64 for attracting metallic particles is disposed inside the sleeve 12. In certain advantageous embodiments, the magnet 64 is a magnetic rod. Due to the elongated shape of the rod, over which the oil flows as it passes through the outflow chamber 86, the oil comes in direct contact with a large surface area of magnetic material. Accordingly, there is a greater likelihood that more metallic particles will be retained. Additionally, because its position in the flow path of the oil is located after both the sleeve 12 and the bypass valve 90, the magnet 64 serves as both a secondary filter for attracting very small particles after the oil has passed through the filter element sleeve 12, and as a back-up filter to provide at least some filtering of the oil when the sleeve 12 is bypassed.

In certain advantageous embodiments, the bypass assembly 30 has an internally threaded cavity 62, and the magnetic rod 64 has a threaded end 65 that is screwed into the cavity 62. In other embodiments, the magnetic rod 64 is integrally formed with the bypass assembly 30.

As illustrated in FIG. 9, in certain advantageous embodiments, a second filter element 102, disposed on a second support member 104, is coupled to the first filter element 12. In some of these embodiments, the first filter element 12 has a different mesh size than the second filter element 102. Accordingly, one filter element with a mesh size for trapping very small particulates can be used without getting clogged as quickly as it normally would, as the other filter element will trap some of the larger particulates, leaving the first filter element free to collect smaller particulates. The second filter element will decrease the likelihood that really large particulates will bypass the filter elements because, even when the smaller-particulate screen gets clogged, the bypass valve 30 will not be immediately activated, as the other filter element will continue to allow oil to pass through it as it traps only larger particulates.

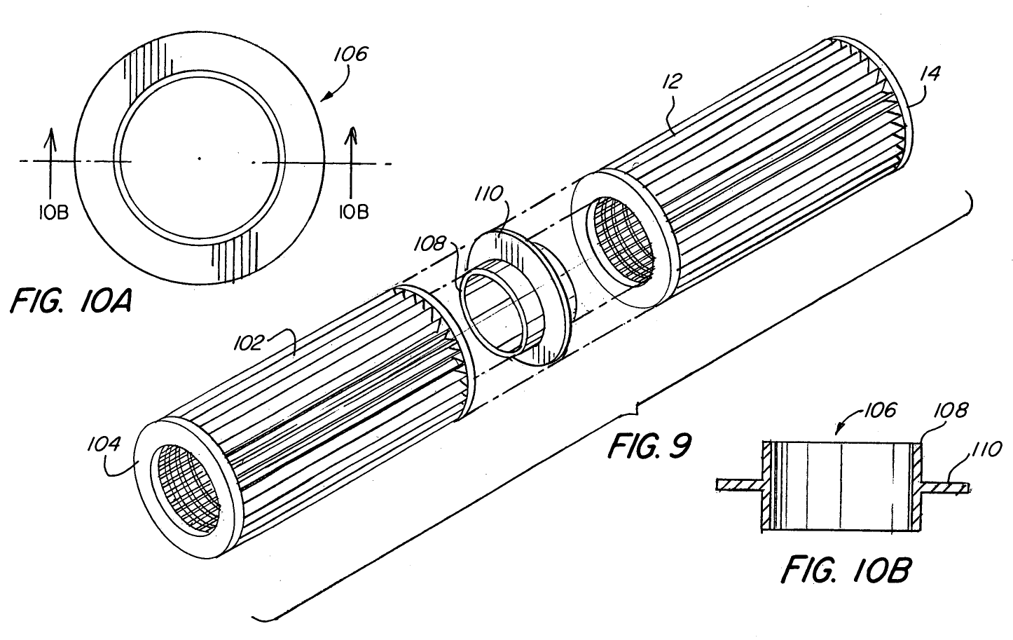

In some of these embodiments, a coupling 106 is provided for coupling the filter elements 12, 102. In the embodiment depicted in FIGS. 9-10, the coupling 106 has a tubular portion 108 and a flange 110. The tubular portion 108 is partially disposed in the first filter element 12 and partially disposed in the second filter element 102, while the flange 110 is disposed between the support members 14, 104.

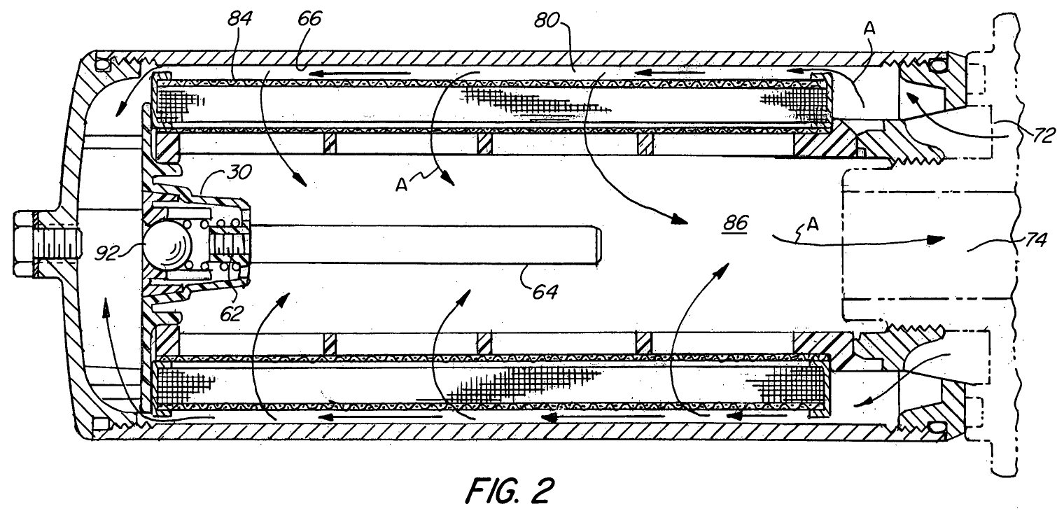

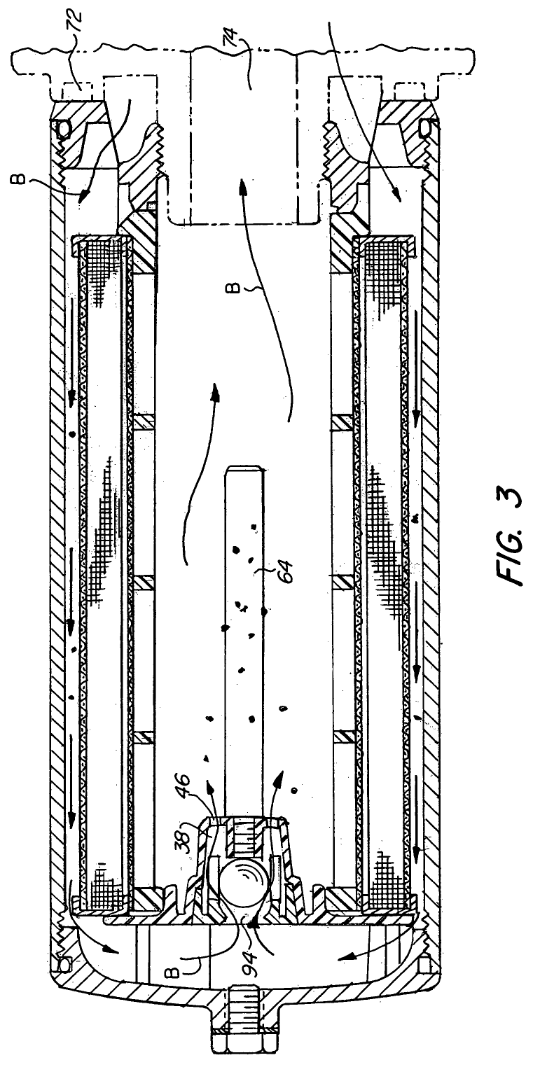

Operation of the above described bypass filter is illustrated stepwise in FIGS. 2-3. As shown in FIG. 2, oil originally flows through the filter 10 along a first fluid pathway, indicated by arrows A. Oil enters the filter 10 via a plurality of housing inlet ports 72 and into the inflow chamber 80 defined as the space between the interior surface 66 of the housing 20 and the exterior surface 84 of the sleeve 12. Because it is closed, the bypass valve 90 serves as a seal 92 between the inflow chamber 80 and the outflow chamber 86. Thus, from the inflow chamber 80, the oil flows through the stainless steel sleeve 12, which removes particulate matter from the oil, into the outflow chamber 86, defined as the space inside the sleeve 12, and over the magnetic rod 64. From the outflow chamber 86, the oil exits the filter 10 via the housing outlet port 74.

As shown in FIG. 3, when the sleeve 12 is sufficiently clogged, or when the oil is sufficiently viscous, the oil flows through the filter 10 along a second fluid pathway, indicated by arrows B. Oil enters the filter 10 via the housing inlet ports 72 and into the inflow chamber 80. Because the oil is unable to flow through the sleeve 12, pressure begins to build in the inflow chamber 80. When a predetermined threshold pressure is met, the bypass valve 90 in the bypass assembly 30 opens, thereby becoming a conduit 94 through which oil can flow.

In the particular embodiments described herein, when the predetermined threshold pressure is met, the oil forces the ball bearing 42 against the spring 44, thereby compressing the spring 44. As the ball bearing 42 moves longitudinally along the tube 58, an aperture 40 becomes unblocked, and the oil flows through the aperture 40. The oil flows through the beveled area 52 of the inner face 54 of the bypass assembly 30, into the tube 58, through slots 60 and into the bypass chamber 38. From the bypass chamber 38, the oil flows through at least one bypass outlet port 46, into the outflow chamber 86. In this way, oil is able to flow through the bypass assembly 30, into the outflow chamber 86, over the magnetic rod 64, and out of the filter 10 via the housing outlet port 74.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A bypass filter assembly comprising:
a main housing having an interior surface;
a filter element disposed in said housing, said filter element having an exterior surface;
an inflow chamber comprising the space between thr interior surface of said housing and the exterior surface of said filter element;
an outflow chamber comprising the space inside said filter element; and
a bypass valve assembly connecting said inflow chamber to said outflow chamber, said valve assembly comprising,
a bypass housing having a bypass chamber, an input end, and an output end,
wherein the input end has an aperture for introducing oil into the bypass chamber;
wherein the output end has at least one outlet port for discharging oil from the bypass chamber;
a spring disposed in the bypass chamber; and
a ball bearing at least partially disposed in the bypass chamber and biased against the aperture by said spring.

2. The filter assembly of claim 1, wherein:
said bypass housing comprises
a base plate having a cavity therein; and
a bypass cap disposed in the cavity; and
the aperture is located in said bypass cap.

3. The filter assembly of claim 1, further comprising a bearing seat, wherein:
the input end of said bypass housing has an inner face; and
said bearing seat comprises a beveled area of the inner face of said bypass housing surrounding the aperture.

4. The filter assembly of claim 1, further comprising a bearing seat, wherein said seat comprises a tube extending into the bypass chamber from the input end of said bypass housing.

5. The filter assembly of claim 4, wherein said tube has at least one slot therein.

6. The filter assembly of claim 1, wherein:
said bypass housing includes a boss extending into the bypass chamber from the output end of said bypass housing; and
said spring is disposed around said boss.

7. The filter assembly of claim 1, further comprising a magnetic rod coupled to the output end of said bypass housing.

8. The filter assembly of claim 7, wherein:
said bypass housing includes an internally threaded boss extending into the bypass chamber from the output end of said bypass housing;
said magnetic rod has a threaded end; and
the threaded end of said rod is screwed into said boss.

9. The filter assembly of claim 8, wherein said spring is disposed around said boss.

10. The filter assembly of claim 1, further comprising a magnetic rod integrally formed with the output end of said base plate and extending outward therefrom.

11. The filter of claim 1, wherein said filter element is a first filter element, further comprising a second filter element disposed in said main housing and coupled to said first filter element.

12. The filter of claim 11, wherein said first filter element has a different mesh size than said second filter element.

13. The filter of claim 12, further comprising:
a first support member on which said first filter element is disposed;
a second support member on which said second filter element is disposed; and
a coupling for connecting said first support member to said second support member, said coupling having a flange;
wherein said coupling is partially disposed in said first support member and partially disposed in said second support member; and
wherein said flange is disposed between said first and second support members.

14. The filter assembly of claim 1, wherein said main housing has at least one housing inlet port and at least one housing outlet port, further comprising:
a first fluid pathway defined when said ball bearing is biased against the aperture, in which oil flows through said housing inlet port, into said inflow chamber, through said filter element, into said outflow chamber, and through said housing outlet port; and
a second fluid pathway defined when said ball bearing is moved away from the aperture, in which oil flows through said housing inlet port, into said inflow chamber, through said aperture, into said bypass chamber, through said bypass outlet port, into said outflow chamber, and through said housing outlet port.

15. A bypass filter assembly, comprising:
a bypass housing having a bypass chamber, an input end, and an output end;
wherein the input end of said housing has an aperture for introducing oil into the bypass chamber;
wherein the output end of said housing has at least one outlet port for discharging oil from the bypass chamber;
a spring disposed in the bypass chamber; and
a ball bearing at least partially disposed in the bypass chamber and biased against the aperture by said spring.

16. The filter assembly of claim 15, wherein:
said bypass housing comprises
a base plate having a cavity therein; and
a bypass cap disposed in the cavity; and
the aperture is located in said bypass cap.

17. The filter assembly of claim 15, further comprising a bearing seat, wherein:
the input end of said bypass housing has an inner face; and
said bearing seat comprises a beveled area of the inner face of said bypass housing surrounding the aperture.

18. The filter assembly of claim 15, further comprising a bearing seat, wherein said seat comprises a tube extending into the bypass chamber from the input end of said bypass housing.

19. The filter assembly of claim 18, wherein said tube has at least one slot therein.

20. The filter assembly of claim 15, wherein:
said bypass housing includes a boss extending into the bypass chamber from the output end of said bypass housing; and
said spring is disposed around said boss.

21. The filter assembly of claim 15, further comprising a magnetic rod coupled to the output end of said bypass housing.

22. The filter assembly of claim 21, wherein:
said bypass housing includes an internally threaded boss extending into the bypass chamber from the output end of said bypass housing;
said magnetic rod has a threaded end; and
the threaded end of said rod is screwed into said boss.

23. The filter assembly of claim 22, wherein said spring is disposed around said boss.

24. The filter assembly of claim 15, further comprising a magnetic rod integrally formed with the output end of said base plate and extending outward therefrom.
